(19) United States
(12) Patent Application Publication
(10) Pub. No.: US 2005/0098909 A1
(43) Pub. Date: May 12, 2005

(54) Tube inverting device and method for using same

(75) Inventor: Larry W. Kiest JR., Ottawa, IL (US)

Correspondence Address: MCKEE, VOORHEES & SEASE, P.L.C., 801 GRAND AVENUE, SUITE 3200, DES MOINES, IA, 50309-2721, US

(73) Assignee: Blue Sky Forever, Inc., Warrenville, IL (US)

(21) Appl. No.: 10/704,886

(22) Filed: Nov. 10, 2003

(51) Int. Cl. B29C 73/00

(52) U.S. Cl. 264/36.17; 425/13; 425/392

(57) ABSTRACT

The tube inverting device of the present invention includes a housing having an inlet opening at one end and an outlet opening at the other end. A liner tube is attached to the outlet opening and extends through the chamber and out of the chamber through the inlet opening. The bladder tube is attached adjacent the inlet opening, and includes a free end extending within the chamber and surrounding the liner tube. Fluid pressure is introduced into the chamber outside the liner tube and the bladder tube and forces the inversion of the liner tube from the outlet opening of the housing while at the same time causing the bladder tube to squeeze against and seal the outer surface of the liner tube.

### BACKGROUND OF THE INVENTION

This invention relates to a tube inverting device and method for using same.

Various methods have been used for delivering a repair liner to a place within a pipe that has been damaged.

One method includes the use of a pressure vessel that houses the liner tube. The vessel is pressurized so as to cause the liner to invert forwardly out of the vessel into the pipe to be repaired. During this inversion process the liner tube is reversed in the same fashion as a sock that is reversed upon itself as it is removed.

One disadvantage of presently existing pressure vessel 5 is that they are large, bulky, and weigh several hundred pounds. The size and weight of the pressure vessel dictates whether or not a repair can be made.

Efforts have been made to reduce the size of the vessel for carrying the liner tube. One of these examples is a chip unit which is shown in FIG. 5 of the drawings. The chip unit is identified by the numeral 10 in FIG. 5 and includes a housing 12 having an open inlet end 14 and an open outlet end 16. A bladder restrictor 18 is attached adjacent the inlet end 14 of the housing 12 and is inflatable. A first pressure inlet 20 is provided for inflating bladder chamber 24 of the bladder restrictor 18.

The housing also includes a second pressure inlet 22 which is utilized for introducing fluid pressure to an inverting chamber 30 within the housing 12.

A liner tube 26 includes a fixed end 28 which is attached adjacent the open outlet end 16 of the housing 12. The liner tube 26 then extends upwardly through the restricted area 27 caused by the bladder restrictor 18. The liner tube then extends upwardly out of the inlet opening 14.

In operation, the first pressure inlet 20 is used to introduce fluid pressure into the interior of the bladder restrictor 18. This causes the bladder restrictor 18 to expand and frictionally engage the outside of the liner tube 26.

Next, fluid pressure is introduced through the second pressure inlet 22 to cause the liner tube 26 to invert outwardly from the open outlet end 16.

The chip unit shown in FIG. 5 has several disadvantages. It requires a bladder 18 that is sealed at its upper and lower ends and requires an independent source of fluid pressure for the bladder 18. This causes the regulation of the amount of squeezing force on the liner tube 26. The squeezing action of the bladder 18 can sometimes squeeze resin from one of the liner tube towards the outer end (upper end as viewed in FIG. 5) of the liner tube. The operator cannot adjust the bladder fluid pressure in a quick fashion which again often results in resin being squeezed from the liner. The liner tubes 26 must have a specific amount of resin to be in compliance with design specifications for a structural liner. Resin being squeezed out is unacceptable.

The chip unit requires regulation of the fluid pressure of the bladder 18 independent of the fluid pressure introduced through the second inlet opening 22.

Another form of prior art device is shown in FIG. 6. This device is designated by the numeral 32 and includes a housing 34 having a restricted inlet 36 and a replaceable head 38. The restrictive inlet 36 is sized to fit the particular liner tube 26, and must be changed for different sized liner tubes 26.

The housing 34 includes a pressure inlet 40 for introducing fluid pressure into the inverting chamber 42.

One disadvantage of the device 32 shown in FIG. 6 is that the head 38 must be changed for different sized tubes 26. The opening 36 is sized to fit the liner 26 snuggly according to its width and thickness in a lay flat hose shape. An amount of fluid escapes passed the opening 36, but enough pressure is maintained between the opening and the turn back or cuff of the liner to force the liner to invert in a forward (downward as viewed in FIG. 6) direction.

The opening in the device 32 has a tendency sometimes to leak too much fluid pressure so that there is not enough fluid between the opening 86 and the turn back or cuff to cause the liner to invert forward. Furthermore, the opening 36 cannot be altered without retooling or changing the entrance end of the device 34. This means that one cannot quickly make the opening smaller or tighter around the liner tube. The opening is fixed until one changes the cap 38 and replaces it with another sized opening. Even then the opening is sometimes not specifically tailored to the size and shape of the liner tube 26.

Therefore, a primary object of the present invention is to provide an improved tube inverting device and method for using same.

A further object of the present invention is the provision of an improved tube inverting device which utilizes a bladder or sealing tube within the inverting chamber, with one end attached to the chamber walls and with the other end free floating.

A further object of the present invention is the provision of an improved tube inverting device which is self adjusting in response to varying fluid pressures within the inverting chamber.

A further object of the present invention is the provision of an improved tube inverting device and method for using same that permits easy control of the speed of the inversion of the liner tube during the inversion process.

A further object of the present invention is the provision of an improved tube inverting device and method for using same which permits the operator to be hands free during the inversion of the liner.

A further object of the present invention is the provision of a tube inverting device and method for using same that is self adjusting, self regulating, and does not apply any more pressure on to the liner than is minimally required for the liner to invert forward into the pipe line.

A further object of the present invention is the provision of a tube inverting device that is economical to manufacture, durable in use and efficient in operation.

### BRIEF SUMMARY OF THE INVENTION

The foregoing objects may be achieved by a tube inverting device comprising a housing enclosing an inverting chamber. The housing includes an inlet opening providing communication from outside the housing into the inverting chamber. It also includes an outlet opening providing communication from the inverting chamber to the outside of the housing. The outlet opening has a perimeter margin extending there around. An elongated liner tube has a first liner tube end, a second liner tube end, and a middle liner tube portion extending between the first and second liner tube ends. The first liner tube end is attached to the perimeter margins of the outlet opening. The middle liner tube portion extends within the inverting chamber and out of the inverting chamber through the inlet opening of the housing. The second end of the liner tube is outside the housing. A sealing tube has a first sealing tube end connected to the housing and a second sealing tube end within the inverting chamber. The sealing tube surrounds and frictionally engages a portion of the liner tube within the inverting chamber. A fluid injector is attached to the housing and provides pressurized fluid into the inverting chamber outside the liner tube and the sealing tube. The result is that the pressurized fluid within the inverting chamber causes the liner tube to be inverted out of the outlet opening and causes the sealing tube to be urged into frictional contact and at least partial sealing engagement with the liner tube.

According to another feature of the present invention the liner tube is impregnated with a liquid resin material that is capable of curing and hardening.

According to another feature of the present invention the liner tube is comprised of an outer layer of moisture impervious material and an inner layer that is impregnated with liquid resin.

According to another feature of the present invention, the liner tube during the inverting process turns inside out, with the inner layer being outside the liner tube and the outer layer being inside the liner tube.

According to another feature of the present invention the sealing tube is comprised of a flexible material that moves against the liner tube in response to the pressurized fluid within the inverting chamber.

According to another feature of the present invention the sewer pipe includes an elongated pipe wall surrounding an elongated pipe bore. The elongated pipe bore has a damaged portion and the housing is used to invert the liner tube for repair of the damaged portion of the elongated pipe.

According to another feature of the present invention the liner tube is collapsed at the point it extends through the inlet opening and the inlet opening is rectangular in shape.

According to another feature of the present invention the outlet opening is circular in shape.

According to another feature of the present invention a pressure gauge is connected to the housing and is in communication with the pressurized fluid within the inverting chamber to register the fluid pressure within the inverting chamber.

According to another feature of the present invention the second end of the sealing tube is free from attachment to the housing or the liner tube.

According to another feature of the present invention the first sealing tube end is attached to the housing so that it surrounds the inlet opening of the housing.

According to the method of the present invention the first liner tube end of the liner tube is attached to the perimeter margins of the outlet opening. The middle liner tube portion is extended through the inverting chamber and the inlet opening of the housing so that the second end of the liner tube is outside the inverting chamber. The sealing tube surrounds a portion of the liner tube with and includes a first sealing tube end attached to the housing and a second sealing tube end within the inverting chamber. Pressurized fluid is introduced into the inverting chamber around both of the liner tube and the sealing tube to cause the liner tube to be inverted out of the outlet opening of the housing and to cause the sealing tube to be urged into frictional contact and at least partial sealing engagement with the liner tube.

According to another feature of the method of the present invention the fluid pressure is changed at different times in the inverting chamber in order to achieve different speeds at which the liner tube is inverted and in order to achieve different sealing pressures of the sealing tube against the liner tube.

According to another feature of the method of the present invention the second liner tube is floated within the inverting chamber so that it is not attached to the housing.

According to another feature of the method of the present invention the first sealing tube end is attached to the housing in surrounding relationship to the inlet opening of the housing.

The foregoing invention overcomes the flaws associated with prior art devices. It is simple and utilizes an opening that will fit a multitude of liner sizes. The system also utilizes a bladder, but the bladder is connected at only one end to the housing. The bladder is attached at that end and allows the other end of the bladder to float free within the chamber of the device. Fluid pressure is introduced into the apparatus between the bladder and the turn back point or cuff of the liner. The fluid pressure begins to squeeze the bladder until the liner begins to move. The faster the liner moves, the less pressure is maintained in the apparatus due to the liner creating a larger area or volume of fluid for receiving the fluid. If the liner begins to slow the rate of inversion, the pressure automatically forces extra bladder pressure against the liner and again relieves itself as the liner begins to invert forward.

The present invention allows installations to be simple and the installation operator to be hands free during the inversion of a liner. It is self-adjusting, self-regulating, and does not apply any more pressure on to the liner than is minimally required for the liner to invert forward into a pipe line.

### BRIEF DESCRIPTION OF THE DRAWINGS

FIG. 1 is a perspective view of the inverting device of the present invention.

FIG. 2 is a sectional view of the inverting device showing the interior of the inverting device.

FIG. 3 is a sectional enlarged view taken along line 3-3 of FIG. 2.

FIG. 4 is a sectional view of a pipe line being repaired with the liner tube inverted therein.

FIG. 5 is a sectional view of a prior art device.

FIG. 6 is a sectional view of another prior art device.

FIG. 7 is a sectional view taken along line 7-7 of FIG. 6.

### DETAILED DESCRIPTION OF THE PREFERRED EMBODIMENT

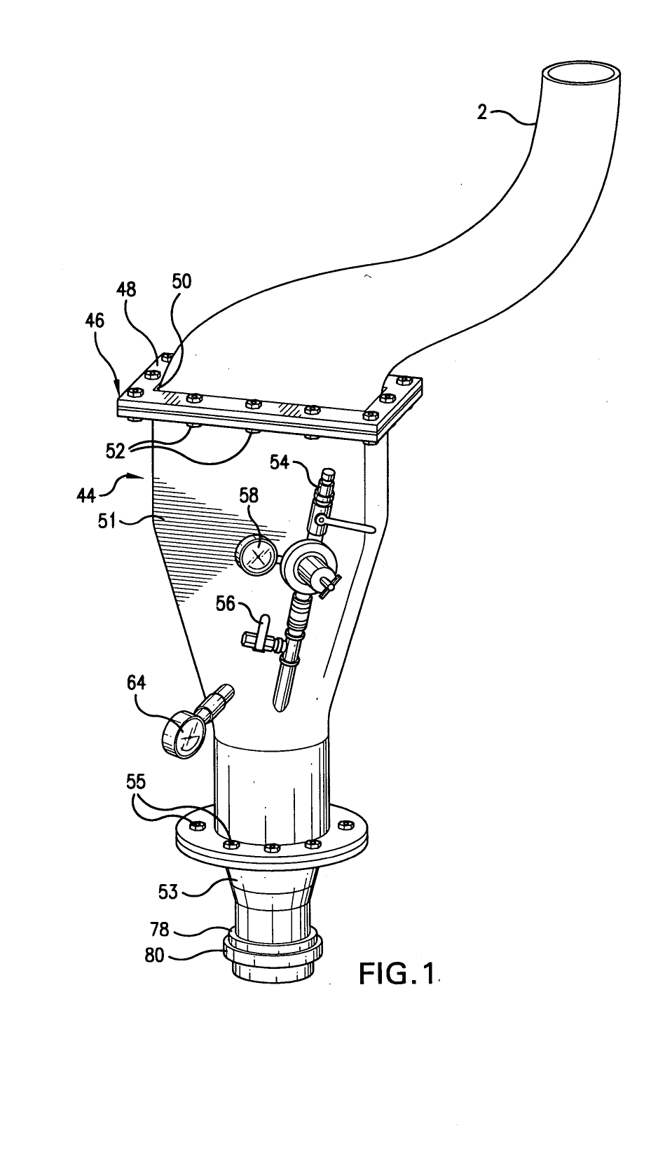

Referring to FIGS. 1-4, the inverting device is generally designated by the numeral 44. Device 44 includes a housing 46 having a removable cap 48 bolted thereon by bolts 52. The cap 48 includes an inlet opening 50 which can be of varying shapes and sizes, but is preferably a rectangular shape sufficient large to receive liner tubes of varying sizes and dimensions.

Housing 46 includes a middle housing section 51 which is bolted at its upper end to cap 48 and which is bolted at its lower end to a bottom housing section 53 by bolts 55.

Within the housing 46 is an inverting chamber 62. A pressure inlet hose 54 includes a shutoff valve 56 and a pressure gauge 58. The pressure inlet hose 54 is in communication with the interior of the inverting chamber 62 through a pressure inlet opening 60.

A chamber pressure gauge 64 is also in communication with the inverting chamber 62 through a gauge opening 66 so as to register the fluid pressure within the inverting chamber 62.

At the outlet end of the housing 46 is an outlet opening 68 which is preferably round in shape. Outlet opening 68 includes an outlet perimeter margin 70.

A liner tube 72 is comprised of an outer moisture impervient layer 74 (FIG. 3) and a moisture absorbent layer 76 on the interior thereof. A liquid resin is impregnated in the inner moisture absorbent layer 76, and is in a liquid state which has not yet cured and hardened. The liner tube 72 includes a first liner tube 78 which surrounds and is attached to the outlet opening 68 of housing 46 by means of a holding band 80. The liner tube 72 includes a second liner tube end 82.

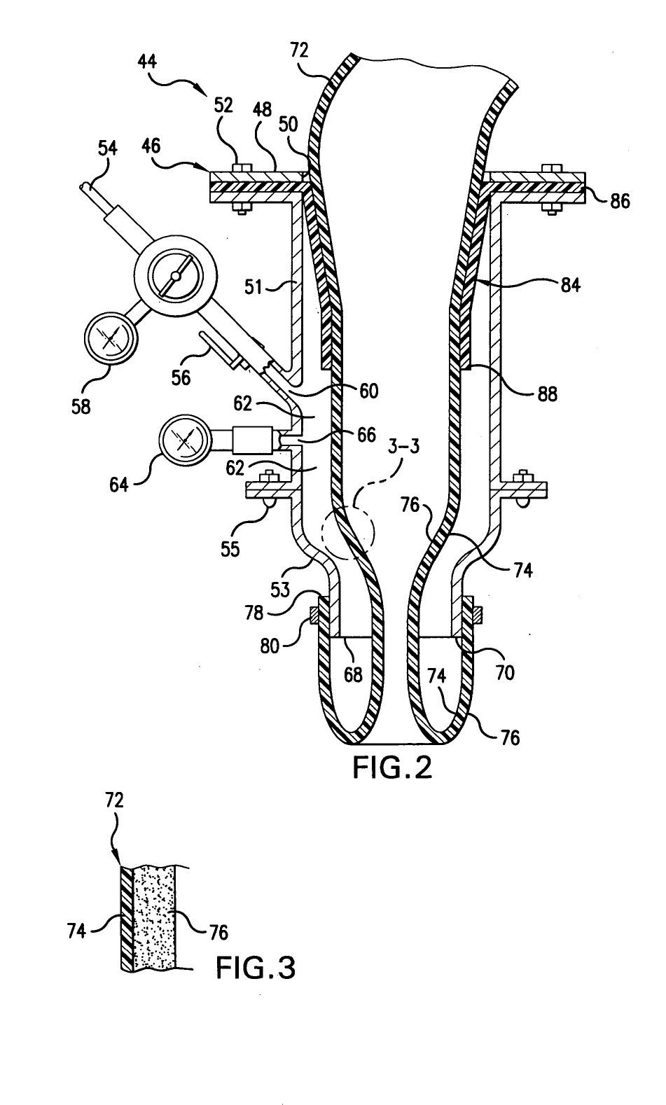

Referring to FIG. 2, a bladder or sealing tube 84 includes a first sealing tube end 86 which is attached to the housing 46. Preferably the first sealing tube end 86 surrounds the inlet opening 50. The bladder or sealing tube 84 includes a second sealing tube end 88 which extends within the inverting chamber 62 and which is not attached to the housing 46 or to the liner tube 72. The lower end 88 of the sealing tube 82 is free floating and is not attached to any object.

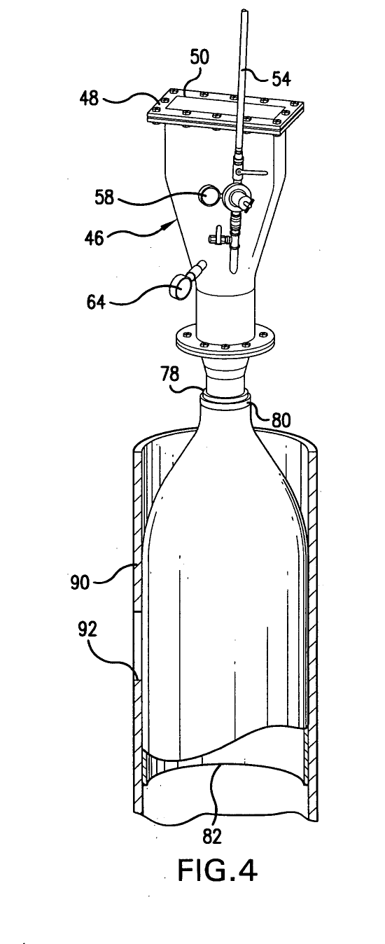

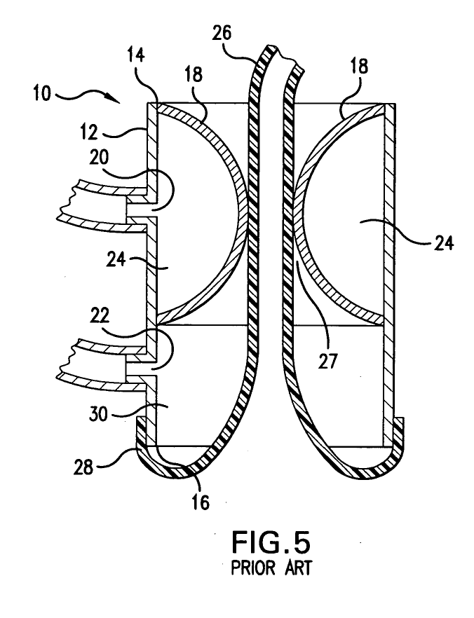

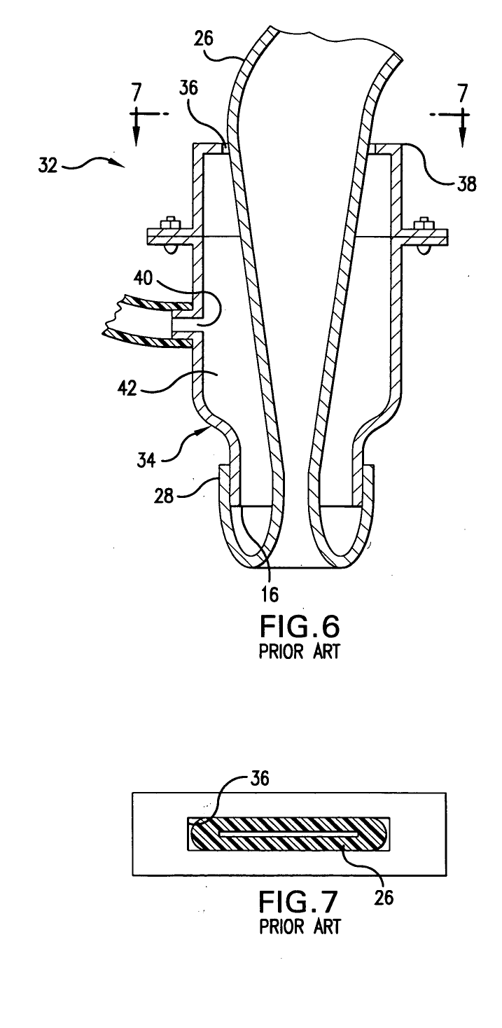

Referring to FIG. 4, a pipe line 90 includes an area 92 which is damaged and needs repair. Within the pipe line 90 is the inverted liner tube 72.

The method of operation of the tube inverting device 44 is as follows. First the first end of the liner tube 78 is incerted into opening 50, through sealing tube 84, and then is attached by means by holding band 80 around the outlet opening 68 of the housing 46. The second end 82 of the liner tube 72 is outside the housing 46. In this position the sealing tube or bladder tube 84 frictionally engages the outer surface of the liner tube 72 as shown in FIG. 2.

Fluid pressure is then inserted from the pressure inlet hose 54 through the pressure inlet opening 60 into the inverting chamber 62. This causes two things to happen. The liner tube 72 begins to invert out of the end of the outlet end 68 of the housing 46. In FIG. 2 the liner tube 72 is shown beginning its inverting action, and as can be seen, the inner moisture absorbent layer 76 is reversed so that it is outside the liner tube 72 after the inversion, and the moisture impervient layer 74 is inside the liner tube 72 after the inversion.

At the same time, the fluid pressure within inverting chamber 62 causes the bladder or sealing tube 84 to be urged into frictional engagement with the outer surface of the liner tube 72. Squeezing action of the sealing tube 84 is greatest adjacent the second or free floating end 88 thereof. This causes a partial or a full seal to be formed between the liner tube 74 and the sealing or bladder tube 84, and therefore traps the fluid pressure within the inverting chamber 62 so as to cause inverting of the liner tube 72. If the fluid pressure within inverting chamber 62 is increased, the friction with which the bladder tube 84 engages the liner tube 72 is also increased, and the inversion of the liner tube 72 is increased in velocity. However, if the fluid pressure within inverting chamber 62 is reduced, the inverting reduces in speed or can actually be made to stop. This provides an easy way to control the velocity at which the inversion process takes place.

When the second liner tube end 82 passes through the slot 50 and ultimately passes outwardly to the position shown in FIG. 4, a cap (not shown) can be placed over slot 50 to hold the fluid pressure within chamber 62. However, even without a cap over slot 50, the bladder tube 84 squeezes sufficiently to permit the immersion of the liner tube 72 to be completed.

In the drawings and specification there has been set forth a preferred embodiment of the invention, and although specific terms are employed, these are used in a generic and descriptive sense only and not for purposes of limitation. Changes in the form and the proportion of parts as well as in the substitution of equivalents are contemplated as circumstance may suggest or render expedient without departing from the spirit or scope of the invention as further defined in the following claims.

1. In combination:
a housing enclosing an inverting chamber;
the housing having an inlet opening providing communication from outside the housing into the inverting chamber;
the housing having an outlet opening providing communication from the inverting chamber to outside the housing, the outlet opening having a perimeter margin extending there around;
an elongated liner tube having a first liner tube end, a second liner tube end, and a middle liner tube portion extending between the first and second liner tube ends;
the first liner tube end being attached to the perimeter margins of the outlet opening, the middle liner tube portion extending within the inverting chamber and out of the inverting chamber through the inlet opening of the housing, and the second liner tube end being outside the housing;
a sealing tube having a first sealing tube end connected to the housing and having a second sealing tube end within the inverting chamber, the sealing tube surrounding and frictionally engaging a portion of the liner tube within the inverting chamber;
a fluid injector attached to the housing and providing pressurized fluid into the inverting chamber outside the liner tube and the sealing tube, whereby the pressurized fluid within the inverting chamber causes the liner tube to be inverted out of the outlet opening and causes the sealing tube to be urged into frictional contact and at least partial sealing engagement with the liner tube.

2. The combination according to claim 1 wherein the liner tube is impregnated with a liquid resin material that is capable of curing and hardening.

3. The combination according to claim 2 wherein the liner tube is comprised of an outer layer of moisture impervious material and an inner layer that is impregnated with the liquid resin.

4. The combination according to claim 3 wherein the liner tube during the inverting process turns inside out, with the inner layer being outside the liner tube and the outer layer being inside the liner tube.

5. The combination according to claim 1 wherein the sealing tube is comprised of a flexible material that moves against the liner tube in response to the pressurized fluid within the inverting chamber.

6. In combination:
a sewer pipe having an elongated pipe wall surrounding an elongated pipe bore, the elongated pipe bore having a damaged portion;
a housing positioned within the elongated pipe bore adjacent the damaged portion of the sewer pipe, the housing enclosing an inverting chamber;
the housing having an inlet opening providing communication from outside the housing into the inverting chamber;
the housing having an outlet opening providing communication from the inverting chamber to outside the housing, the outlet opening having a perimeter margin extending there around;
an elongated liner tube having a first liner tube end, a second liner tube end, and a middle liner tube portion extending between the first and second liner tube ends;
the first liner tube end being attached to the perimeter margins of the outlet opening, the middle liner tube portion extending within the inverting chamber and out of the inverting chamber through the inlet opening of the inverting chamber, and the second liner tube end being outside the housing;
a sealing tube having a first sealing tube end connected to the housing and having a second sealing tube end within the inverting chamber, the sealing tube surrounding and frictionally engaging a portion of the liner tube within the inverting chamber;
a fluid injector attached to the housing and providing pressurized fluid into the inverting chamber outside the liner tube and the sealing tube, whereby the pressurized fluid within the inverting chamber causes the liner tube to be inverted out of the outlet opening and causes the sealing tube to be urged into frictional contact and at least partial sealing engagement with the liner tube.

7. The combination according to claim 6 wherein the liner tube is collapsed at the point it extends through the inlet opening and the inlet opening is rectangular in shape.

8. The combination according to claim 7 wherein the outlet opening is circular in shape.

9. The combination according to claim 6 wherein a pressure gage is connected to the housing and is in communication with the pressurized fluid within the inverting chamber to register the fluid pressure within the inverting chamber.

10. The combination according to claim 6 wherein the second end of the sealing tube is free from attachment to the housing or to the liner tube.

11. The combination of claim 6 wherein the first sealing tube end is attached to the housing so that it surrounds the inlet opening of the housing.

12. A method for inverting a liner tube comprising:
taking a housing having an inverting chamber therein, the housing having an inlet opening providing communication from outside the housing into the inverting chamber, the housing having an outlet opening providing communication from the inverting chamber to outside the housing, the outlet opening having a perimeter margin extending there around;
attaching a first liner tube end of a liner tube to the perimeter margins of the outlet opening;
extending a middle liner tube portion of the liner tube through the inverting chamber and the inlet opening of the housing so that a second tube end of the liner tube is outside the inverting chamber;
surrounding a portion of the liner tube with a sealing tube having a first sealing tube end attached to the housing and a second sealing tube end within the inverting chamber;
introducing pressurized fluid into the inverting chamber around both of the liner tube and the sealing tube to cause the liner tube to be inverted out of the outlet opening of the housing and to cause the sealing tube to be urged into frictional contact and at least partial sealing engagement with the liner tube.

13. The method according to claim 12 and further comprising changing the fluid pressure introduced into the inverting chamber in order to achieve different speeds at which the liner tube is inverted and in order to achieve different sealing pressures of the sealing tube against the liner tube.

14. The method according to claim 13 and further comprising floating the second liner tube end within the inverting chamber so that it is not attached to the housing.

15. The method according to claim 12 and further comprising attaching the first sealing tube end to the housing in surrounding relationship to the inlet opening of the housing.
